(19) United States
(12) Patent Application Publication
(10) Pub. No.: US 2015/0353385 A1
(43) Pub. Date: Dec. 10, 2015

(54) HYDROPHOBIC PHOTOTHERMAL MEMBRANES, DEVICES INCLUDING THE HYDROPHOBIC PHOTOTHERMAL MEMBRANES, AND METHODS FOR SOLAR DESALINATION

(71) Applicant: King Abdullah University of Science and Technology, Thuwal (SA)

(72) Inventors: Peng Wang, Thuwal (SA); Lianbin Zhang, Thuwal (SA)

(21) Appl. No.: 14/724,858

(22) Filed: May 29, 2015

Related U.S. Application Data
(60) Provisional application No. 62/009,446, filed on Jun. 9, 2014.

(51) Int. Cl. C02F 1/44; B01D 67/00; B01D 61/36; B01D 71/62; B01D 69/12

(52) U.S. Cl. CPC C02F 1/448; B01D 71/62; B01D 69/127; B01D 61/362; B01D 67/0037; B01D 61/366; C02F 2101/10

(57) ABSTRACT

Embodiments of the present disclosure provide structures or membranes including photothermal nanomaterials, devices including the structure, methods of use, methods of desalination, and the like.

### CROSS-REFERENCE TO RELATED APPLICATIONS

This application claims the benefit of and priority to U.S. Provisional Application Ser. No. 62/009,446, having the title “SUPERHYDROPHOBIC PHOTOTHERMAL MEMBRANES, DEVICES INCLUDING THE SUPERHYDROPHOBIC PHOTOTHERMAL MEMBRANES, AND METHODS FOR SOLAR DESALINATION,” filed on Jun. 9, 2014, the disclosure of which is incorporated herein in by reference in its entirety.

### BACKGROUND

There is an acute scarcity of potable water in the semi-arid, desert regions, land scarce countries as well as countries of high economic activities of the world, where a major focus is now on desalination to meet the ever growing water demand by desalting seawater, brackish and recycled water. A number of seawater desalination technologies have been developed and implemented industrially during the last several decades to augment the supply of water, such as multi-stage flash distillation, reverse osmosis, membrane distillation, and electrodialysis. However, due to the high energy consumption in these processes, more sustainable desalination methods that utilize alternative energy resources are still highly desired in the face of rising energy cost and diminishing fossil fuel stock. Especially, in remote and rural areas where access to centralized drinking water supply and even electricity is unavailable, a point-of-use desalination system, driven by renewable energy, is not only more preferable, but also the only choice, which unfortunately is hardly achievable by the existing technologies.

### SUMMARY

Embodiments of the present disclosure provide structures or membranes including photothermal nanomaterials, devices including the structure, methods of use, methods of desalination, and the like.

An embodiment of the present disclosure includes a hydrophobic photothermal membrane, among others, that includes: a porous structure having a hydrophobic or superhydrophobic surface and a plurality of photothermal nanomaterials, wherein the surface has a characteristic selected from a hydrophobic characteristic or a superhydrophobic characteristic.

An embodiment of the present disclosure includes a water distillation device, among others, that includes: a hydrophobic photothermal membrane a porous structure having a hydrophobic or superhydrophobic surface and a plurality of photothermal nanomaterials, wherein the surface has a characteristic selected from a hydrophobic characteristic or a superhydrophobic characteristic, a condensation unit, wherein the membrane and the condensation unit are partially separated by a wall, wherein water vapor permeates the photothermal membrane and condenses in the condensation unit.

An embodiment of the present disclosure includes a process of desalination, among others, that includes: placing a device on the surface of a body of saltwater or wastewater, wherein the device floats on the surface of the water; exposing the membrane to a light energy, wherein the light energy is converted to thermal energy, wherein the thermal energy causes the porous substrate to increase in temperature; vaporizing the water in contact with the bottom surface of the membrane on the side opposite the photothermal nanoparticles, wherein the water vapor passes through the pores of the porous substrate; and condensing the water vapor in a condensation unit that is separated from the membrane. In an embodiment, the device includes a hydrophobic photothermal membrane, comprising a porous structure having a hydrophobic or superhydrophobic surface and a plurality of photothermal nanomaterials, wherein the surface has a characteristic selected from a hydrophobic characteristic and a superhydrophobic characteristic, a condensation unit, wherein the membrane and the condensation unit are partially separated by a wall, wherein water vapor permeates the photothermal membrane and condenses in the condensation unit.

### BRIEF DESCRIPTION OF THE DRAWINGS

FIG. 1.1 illustrates an experimental setup for the measurement of the water evaporation rate by the superhydrophobic photothermal membrane.

FIG. 1.2 illustrates a schematic configuration of the point-of-use device for the direct and all-in-one solar desalination.

FIG. 1.3 illustrates a schematic of a superhydrophobic photothermal membrane for solar desalination. HT: high temperature; RT: room temperature. Due to the photothermal effect of the membrane, a local HT can be achieved at the air/water interface.

FIGS. 2.1A-D illustrate the preparation of the interfacial heating membrane on stainless steel mesh. (A) Schematic illustration for the preparation of the light-to-heat conversion membrane for interfacial heating. Due to the hydrophobicity, the PPy-coated SS mesh stays spontaneously at the water-air interface and converts light energy to heat, locally heating the surface water. (B) SEM images of the original smooth SS mesh surface (B1), and the PPy-coated mesh surface with microstructures (B2). Insets in (B1) and (B2) show the magnified view of the knitting wire surfaces. (C) Dependence of the thickness of the PPy coating on the electropolymerization time. (D) Water contact angles of the PPy-coated SS meshes after the hydrophobic modification. Insets in (D) show the shapes of a water droplet on the membrane at different tilt angles of 0° (contact angle about)140°, 90° and 180°, showing a typical Wenzel's wetting behavior.

FIGS. 2.2A-C illustrate the extinction (A), reflection (B), and transmission (C) spectra of the PPy-coated ITO glasses, with black curves being bare ITO glass, red, blue, pink and green curves being PPy-coated ITO glass by 5, 15, 30, and 60 min electropolymerization, respectively.

FIGS. 2.3A-B illustrate a photothermal property of the PPy-coated SS mesh. (A) The steady-state temperatures of the PPy-coated SS meshes in air as a function of the thickness of the PPy coating, under the solar irradiation. (B) Time-course of the temperature of the original SS mesh and the PPy-coated (thickness ˜2.6 μm) SS mesh under the solar light irradiation. Red and black arrows indicate the time when the light was turned on and off for each sample, respectively. Insets in (B) show the IR thermal images of the PPy-coated versus original SS meshes under the solar light irradiation. The markers (+) in the thermal images show the spots where time-course of the temperature curves were recorded.

FIGS. 2.4A-F illustrate an enhanced water evaporation by the hydrophobic photothermal membrane. (A) Schematic illustration for the setup of the water evaporation measurement with the PPy-coated SS mesh floating on the water surface. Inset in (A) shows the digital photograph of the mesh floating on the water surface in a beaker. (B) Time course of water evaporation performance under various conditions. Black: water without light irradiation. Red: water under the light irradiation. Blue: water with an original SS mesh with hydrophobic modification. Pink, green, purple, and brown: water with floating SS meshes of different PPy coating thicknesses. (C) The water evaporation as a function of the thickness of the deposited PPy coatings on the SS mesh for 10 hours. (D) IR thermal images of water beakers without light (left panel), with light irradiation on for 20 seconds (middle panel) and for 2 hours (right panel). Left beaker: water only. Right beaker: water with the floating PPy-coated mesh on surface. (E) Temperature profiles of the marked lines in right panel of (d). (F) The surface temperature of the water with (▪, right beaker) and without (□, left beaker) the PPy-coated mesh under the solar light irradiation.

FIG. 2.5 illustrates a schematic configuration of the point-of-use device for direct and all-in-one solar distillation for freshwater production.

FIG. 2.6 illustrates SEM images of the PPy-coated SS meshes with different electropolymerization time. Insets: magnified view of the knitting wire surfaces.

FIGS. 2.7A-C illustrate the time course of water evaporation on A) PPy-coated SS mesh (500 mesh), B) PPy-coated SS mesh (80 mesh), and C) superhydrophobic Cu mesh. The wetting behaviors of the droplets on the SS mesh (80 mesh) and the superhydrophobic Cu mesh are shown in the insets on the left of the Figures. The PPy-coated SS mesh (80 mesh) exhibited similar wetting behavior to 500 mesh one, with a water contact angle of ˜137°, and a high adhesion to the water droplet. Even the mesh with the water droplet on it was reverted, the water droplet still firmly attached to the mesh, demonstrating a Wenzel's wetting state. For the superhydrophobic Cu mesh, it showed a water contact angle of 157° and sliding angle less than 1°, which indicates a Cassie's wetting behavior. The wetting behavior of the 500 mesh was shown in the FIG. 2.1d.

FIG. 2.8 illustrates a comparison of the water evaporation with the hydrophilic and hydrophobic PPy-coated SS meshes as a function of time. Inset shows the digital photographs (side view and top view) of the hydrophilic mesh self-sitting at the bottom of the water.

FIGS. 2.9A-C illustrate: A) IR thermal images of water with the hydrophilic PPy-coated SS mesh before light irradiation (left) and after 2 h light irradiation (right). B) The time course of surface temperature of the water in the beaker with the hydrophilic PPy-coated SS mesh self-sitting at the bottom of the beaker under the solar light irradiation. C) Temperature profiles of the marked lines in right panel of (A).

FIG. 2.10 illustrates a simulated seawater evaporation under various conditions. A 3.5% NaCl solution was used to simulate seawater in the experiment. The used mesh size was 500 mesh and the PPy coating was prepared by 1 hour electropolymerization. For the hydrophilic PPy-coated mesh, no fluorosilane modification was conducted.

FIG. 2.11 illustrates water evaporation with the floating PPy-coated SS meshes having different mesh sizes. The PPy coatings on these meshes were all prepared by 1 hour electropolymerization of pyrrole, followed by fluorosilane modification. For the 80 mesh, the wire diameter is about 110 μm, and the pore size is about 190 μm. For the 200 mesh, the wire diameter is about 48.7 μm, and the pore size is about 75.5 μm. For the 325 mesh, the wire diameter is about 34.6 μm, and the pore size is about 46.9 μm. For the 500 mesh, the wire diameter around ˜24.5 μm, and the pore size is about 26.8 μm.

FIG. 2.12 illustrates digital photograph of the point-of-use device for direct and all-in-one solar distillation.

### DETAILED DESCRIPTION

Embodiments of the present disclosure provide structures or membranes including photothermal nanomaterials, devices including the structure, methods of use, methods of desalination, and the like. Embodiments of the present disclosure are advantageous because embodiments of the present disclosure provide for high efficiency energy conversion of light to heat, which can be used in desalination devices and methods. Embodiments of the present disclosure can be used to convert salt water to drinking water. Additional details and advantages are described herein and in the Examples.

### Definitions

As used herein “contact angle” refers to the angle at which the liquid-vapor interface meets the solid-liquid interface of a fluid in contact with a surface. The contact angle provides an inverse measure of wettability.

As used herein, “hydrophobic surface”, “hydrophobic characteristic” refers to a surface that is not wettable by water or the surface has the characteristic that it is not wettable by water. These surfaces or those that have the hydrophobic characteristic can produce surface-liquid interactions that have high contact angles.

As used herein, “superhydrophobic surface”, “superhydrophobic substrate”, or “superhydrophobic characteristic” refers to a surface where the surface-water interaction has a contact angle of greater than 150 degrees or where the surface has the characteristic that the surface-water interaction has a contact angle of greater than 150 degrees.

As used herein, “wettability” refers to the degree of wetting by a liquid.

As used herein, “wetting” refers to the ability of a liquid to maintain contact with a surface, which results from intermolecular interactions when the liquid is brought into contact with the surface.

### Discussion

Embodiments of the present disclosure can be used for high energy-efficient point-of-use solar desalination. Embodiments of the present disclosure combine the photothermal effect of nanomaterials and, optionally, surface hydrophobicity, to precisely target local heating of interfacial water at surface/water interface. In an embodiment, the device floats on water (e.g., salt water) due to a portion of the device having a hydrophobic or superhydrophobic characteristic. Compared to bulk water heating systems where a homogeneous high temperature is required for the entirety of the bulk water, a depth-dependent temperature gradient with a locally high temperature at the water surface is achieved using embodiments of the present disclosure, which effectively drives water vapor, once generated, to leave the water surface, move into the air phase, and be captured. In this regard, embodiments of the present disclosure can be highly energy efficient at desalination.

An embodiment of the present disclosure includes a structure that includes a substrate or membrane (e.g., a heat conductive porous substrate or membrane) having a plurality of photothermal nanomaterials disposed thereon. As described herein, the photothermal nanomaterial converts light energy into thermal energy, which can be used to heat the heat conductive porous substrate. In this way, light energy from the sun can be efficiently converted to thermal energy, which can be used to heat water that is in contact with the substrate or membrane. The water at the water-substrate interface can be vaporized, and subsequently collected. For example, the vaporized water can flow through the pores of the heat conductive porous substrate or membrane and can subsequently be collected in a condensation unit, which is described in more detail below.

In an embodiment, the photothermal nanomaterial can include a material such as: gold nanoparticles, nanowires or nanorods; graphene nanosheets; carbon nanotubes; carbon black, carbon nanofibers; silver nanoparticles, nanowires, or nanorods; polypyrrole nanoparticles, nanowires, or nanorods; polyaniline nanoparticles, nanowires, or nanorods; polythiophene nanoparticles, nanowires, or nanorods; poly(3,4-ethylenedioxythiophene) nanoparticles, nanowires, or nanorods; platinum polypyrrole nanoparticles, nanowires, or nanorods; CuS, CuO, CuSe, nanoparticles; porous silicon nanoparticles, iron oxide nanoparticles, nanowires, or nanorods, or a mixture thereof, or mixture thereof. In an embodiment, different types of photothermal nanomaterials can be used on a single substrate. In an embodiment, techniques such as spray coating, dip coating, layer-by-layer (LbL) assembly deposition, chemical vapor deposition, physical vapor deposition, or by a combination thereof, can be used to dispose the photothermal nanomaterials on the substrates. In an embodiment, the diameter (or longest dimension for non-spherical particles) of the photothermal nanomaterial can be about 2 to 200 nm or about 10 to 100 nm.

In an embodiment, the substrate (e.g., membrane) can include a material that has mechanical stability and is cost effective as well as conducts heat. In an embodiment, the substrate is porous so that water vapor can flow through the pores of the substrate and are subsequently collected. In an embodiment, the substrate can be a metallic mesh such as an aluminum, copper, bronze or stainless steel metallic mesh. In an embodiment, the substrate can be an electrospun polymeric (e.g., polystyrene, nylon, polysulfone, poly(ethylene terephthalate) polytetrafluoroethylene, polyethylene, polypropylene polyvinylidene fluoride, or the like or inorganic nanofiber (e.g., SiO₂, TiO₂, or carbon nanofibers, or the like) mat. In an embodiment, the substrate can be a sponge. In an embodiment, the substrate can be paper. In an embodiment, the substrates can be a polymeric membrane.

In an embodiment, the mesh can be made of a material such as: copper, iron, nickel, titanium, aluminum, silver, gold, palladium, platinum, silicon, zirconium, cobalt, lead, an alloy thereof, an oxide thereof, or a mixture thereof.

In an embodiment, the paper, the polymeric membrane, and electrospun fibrous mat can be made of a material such as: cellulose, nylon, polyester, polyethylene terephthalate, polyurethane polylactide, polypropylene, polyethylene, polysulfone, polyamide, polyvinyl chloride, polytetrafluoroethylene, polycarbonate, polyacrylonitrile, polybuylene polybutylene terephthalate, polyimide, polymethyl, methacrylate, polyetheretherketone, polyetherketone, polyetherimide, polyethersulfone, polymethylpentene, polyoxymethylene, polyphthalamide, polyphenylene oxide, polyphenylene sulfide, ethylene propylene rubber, styrene butadiene rubber, ethylene propylene diene monomer rubber, polydimethylsiloxane, poly(phenyl methyl siloxane), poly(4-dimethylsilyl styrene), poly(4-methyl styrene), poly(isobutylene), poly(N-isopropylacrylamide), polyacrylamide, polypyrrole, polythiophene, polyaniline, or a mixture or blend thereof.

In an embodiment, the sponge can be made of a material such as: cellulose, nylon, polyester, polyethylene terephthalate, polyurethane polylactide, polypropylene, polyethylene, polysulfone, polyamide, polyvinyl chloride, polytetrafluoroethylene, polycarbonate, polyacrylonitrile, polybuylene polybutylene terephthalate, polyimide, polymethyl, methacrylate, polyetheretherketone, polyetherketone, polyetherimide, polyethersulfone, polymethylpentene, polyoxymethylene, polyphthalamide, polyphenylene oxide, polyphenylene sulfide, ethylene propylene rubber, styrene butadiene rubber, ethylene propylene diene monomer rubber, polydimethylsiloxane, poly(phenyl methyl siloxane), poly(4-dimethylsilyl styrene), poly(4-methyl styrene), poly(isobutylene), poly(N-isopropylacrylamide), polyacrylamide, polypyrrole, polythiophene, polyaniline, or a mixture or blend thereof.

In an embodiment, the substrate can have a thickness of about 10 nm to 100 μm, which includes each increment as measured by 10 nm or 100 nm. In an embodiment, the pores extend through the substrate and can have a diameter of about 5 nm to 1 mm, which includes each increment as measured by 10 nm or 100 nm. In an embodiment, the pores may have the same diameter through the substrate, the pores may have a variable diameter through the length of the pore, or a combination of pore diameters, and/or variability in pore diameter. In an embodiment, the top of the substrate is the side having the photothermal nanoparticles and the bottom is the side that contacts the water.

As mentioned above, the substrate can be hydrophobic or superhydrophobic (e.g., have a hydrophobic or superhydrophobic characteristic) or the substrate can be modulated so that the surface of the substrate can be hydrophobic or superhydrophobic. In an embodiment, the phrase “superhydrophobic or hydrophobic” can be referred to as “hydrophobic” for clarity, but can be differentiated based on the definitions provided herein for purposes of claiming, arguments, and the like.

In an embodiment, the surface of the substrate can be modified to be hydrophobic by disposing a low surface energy chemical to the surface of the substrate. In an embodiment, the low surface energy chemical can be applied to the bottom of the substrate (the side opposite the side with the photothermal nanoparticles), the pore walls, and/or the top side including the photothermal nanoparticles (e.g., including the photothermal nanoparticles as long as it does not significantly alter the function of the low surface energy chemical). Use of a hydrophobic substrate or modulating the hydrophobicity of the surface of the substrate can enhance energy efficiency of the structure and at the same time make the structure self-floating so that the interfacial water is locally heated. In addition, the hydrophobic surface enhances water bubble nucleation and speeds up evaporation so that the water vapor is driven away from the surface of the substrate and flows through the pores of the substrate without condensation. In an embodiment, the low surface energy chemical can include fluorosilanes (e.g., 1H,1H,2H,2H-perfluorooctyltriethoxysilane, 1H,1H,2H,2H-perfluorododecyltrichlorosilane, 1H,1H,2H,2H-perfluorodecyltriethoxysilane, or trichloro(3,3,3-trifluoropropyl)silane), alkysilanes (e.g hexyltrimethoxysilane, dimethoxy(methyl)octylsilane), trichloro(octadecyl)silane, trichloro(octyl)silane, or trimethoxy(octadecyl)silane, or a combination thereof.

Thus, embodiments of the substrates can include heat conductive porous substrates and heat conductive, hydrophobic, porous substrates.

In an embodiment, the structure can be included in a device that can be used in water vaporization, in particular, desalination. An embodiment includes a structure (e.g., that include the porous substrate) and a condensation unit, where the structure and the condensation unit are positioned in a housing structure. The housing structure can be constructed of a material suited for the environment for which the device is used. In an embodiment, a portion (e.g., top and/or sides) can be made of a material that is transparent to light energy that the photothermal nanoparticles absorb and convert into thermal energy. In an embodiment, the structure and the condensation unit are disposed in different areas of the device so that the water vapor can be effectively generated and the water vapor can be efficiently condensed and collected. In an embodiment, a wall or other partition separates the area where the condensation unit and substrate are positioned, while a circulation device (e.g., fan) can be used to flow the water vapor to the condensation unit.

When the photothermal nanoparticles absorb light energy, the light energy is converted into thermal energy that heats the porous substrate. As a result, a depth-dependent temperature gradient with a locally high temperature at the water surface is achieved since the device floats on the surface of a body of water. The thermal energy causes the interfacial water to vaporize and flow through the pores of the porous substrate into the atmosphere of the housing structure. The areas that the substrate and the condensation unit are positioned are separated by a wall(s) with opening so that the water vapor flows toward the condensation unit. The water vapor is condensed and collected in the condensation unit.

In an embodiment, the condensation unit includes a chamber with cold surfaces, which can be made of glass, silicon, or metal for the condensation of water vapor. In an embodiment, the condensation unit can include other components to collect and store the water.

An embodiment of the present disclosure includes a method of desalination of salt water. The method can use the substrates and devices described herein. In an embodiment, the method includes placing a device on the surface of a body of salt water, where the device floats on the surface of the salt water. In an embodiment, the salt water can include brackish water, sea water, lake salt water, waste water, and the like. The photothermal nanoparticles are exposed to a light energy and the light energy is converted to thermal energy, where the thermal energy causes the porous substrate to increase in temperature. The water in contact with the bottom surface of the membrane is heated and vaporized. Once vaporized, the water vapor passes through the pores of the porous substrate. Subsequently, the water vapor is condensed in a condensation unit.

### EXAMPLES

While embodiments of the present disclosure are described in connection with the Examples and the corresponding text and figures, there is no intent to limit the disclosure to the embodiments in these descriptions. On the contrary, the intent is to cover all alternatives, modifications, and equivalents included within the spirit and scope of embodiments of the present disclosure.

### Example 1

There is an urgent demand of developing sustainable point-of-use desalination method to supply fresh water in remote and rural areas where access to centralized drinking water supply and even electricity is unavailable. Herein, for the purpose of highly energy-efficient point-of-use solar desalination, our design, which combines photothermal effect of nanomaterials and surface superhydrophobicity to precisely target local heating of interfacial water at air/water interface. The device will be fabricated based on porous mesh/membrane as a substrate to house the photothermal nanomaterials, including metallic nanostructures, carbon nanotubes, graphene nanosheets, or carbon black. The wettability of the substrate will be modulated so that it is superhydrophobic, which would enhance energy efficiency of the device and at the same time make the device a perfectly self-floating device which stays on the surface of water and thus guarantees the local heating of interfacial water. Compared to bulk water heating system where a homogeneous high temperature is required for the entirety of the bulk water, a depth-dependent temperature gradient with a locally high temperature at the water surface is achieved in the proposed superhydrophobic photothermal membrane system, which effectively drives water vapor, once generated, to leave the water surface and move into the air phase and thus enhances the energy efficiency. The proposed device, once prepared, would be suitable and affordable for direct point-of-use applications to supply household drinking water.

### Introduction:

There is an acute scarcity of potable water in the semi-arid, desert regions, land scarce countries as well as countries of high economic activities of the world, where a major focus is now on desalination to meet the ever growing water demand by desalting seawater, brackish and recycled water.^{1,2} A number of seawater desalination technologies have been developed and implemented industrially during the last several decades to augment the supply of water, such as multi-stage flash distillation, reverse osmosis, membrane distillation, and electrodialysis.³ However, due to the high energy consumption in these processes, more sustainable desalination methods that utilize alternative energy resources are still highly desired in the face of rising energy cost and diminishing fossil fuel stock. Especially, in remote and rural areas where access to centralized drinking water supply and even electricity is unavailable, a point-of-use desalination system, driven by renewable energy, is not only more preferable, but also the only choice, which unfortunately is hardly achievable by the existing technologies.⁴

Among all kinds of energy resources, solar energy is without any doubt the most renewable, safe, and the most abundant energy source available to us all.⁵ The solar energy that strikes the earth surface in two hours is more than the total energy consumption of the entire world in a year.⁵ Solar energy powered desalination processes have been explored in the past decade, one of which involves direct use of solar collectors to evaporate water and is generally termed as solar still.⁶ Solar still, which could be applied as a point-of-use system, possesses a major difficulty of low heating efficiency, mainly because of its undesirably low solar light absorption and therefore, a solar concentrator or collector is usually required to enhance water evaporation in the solar still. However the solar concentrator and collector have their own shortcomings, including high energy losses due to light scattering and reflection.⁷ As a result, the world is still actively searching for new ways of solar energy powered desalination to have both its water and energy demands met in a sustainable manner.

Recently, it has been revealed that some metallic nanostructures are capable of effectively and directly inducing light-to-heat conversion under light illumination within solar light spectrum.⁸ The mechanism is generically referred to as photothermal effect in which the metallic nanostructures actively absorb optical radiation due to the collective oscillations of their delocalized conduction electrons, known as surface plasmons. When excited on resonance, the plasmons do not re-radiated its energy through light emission and its energy is dissipated via a non-radiative way, namely Landau damping, which leads to a dramatic rise in temperature in the nanometer-scale vicinity of the nanostructure surface.⁹

It has also been recently revealed that this non-radiative photothermal effect is not a proprietary property of the metallic nanostructures and certain carbon-based nanomaterials, such as carbon nanotubes, graphene nanosheets, have been demonstrated to possess the same photothermal effect as they are able to absorb light from the ultraviolet (UV) to near infrared (NIR) ends of the solar spectrum and convert it into heat through the non-radiative decay.¹⁰ The photothermal effect of these relevant nanomaterials are believed to be a highly energy-efficient way of generating dramatic localized heating as the non-radiative decay minimizes the energy loss via light radiation and thus is believed to be heating method of future.

### Discussion:

The nanomaterials with the photothermal effect have been widely employed for the photothermal treatment of various medical conditions, including cancer therapy.¹¹ However, when it comes to water evaporation, the current photothermal nanomaterial based bulk-water heating faces major challenges: (1) the bulk water heating necessitates uniform dispersion of the photothermal nanomaterials in the bulk water, which undesirably leads to relatively low heating efficiency. Under the bulk water heating scheme, the entire bulk water has to be heated to a high temperature so to speed up evaporation, resulting in unnecessary heat/energy loss. In many literature-reported systems, in order to induce significant water evaporation, high nanomaterial concentration and/or high incoming light density are usually employed;⁸⁻¹⁰ (2) the nanomaterials dispersed in water, usually with particle size smaller than 100 nm, are difficult to recycle, which contributes to the high operation cost. In addition, applying the photothermal nanomaterials for seawater desalination is deemed even more problematic and thus a daunting task as the nanomaterials are inclined to aggregation, due to the high ionic strength of seawater, which leads to subsequent sedimentation of particle aggregates out of the water.¹² Thus, it is not a surprise that the report on photothermal nanomaterials for water desalination is virtually nonexistent.

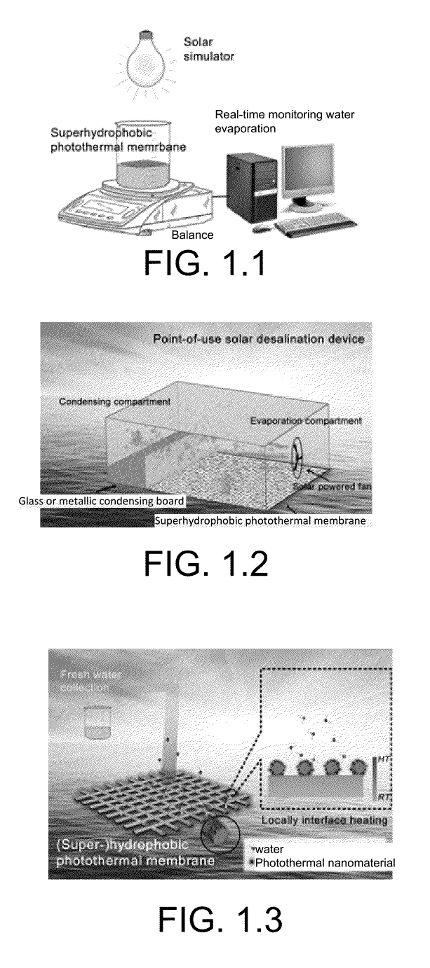

Aiming at overcoming the abovementioned difficulties and at producing the first example of photothermal water desalination device with unparalleled solar energy efficiency, herein, our design, which combines photothermal effect and surface superhydrophobicity to target local heating of interfacial water at air/water interface. Given the unnecessary heat loss in the bulk water heating scheme, targeting the interfacial water becomes rational solution to further improve the energy efficiency. Furthermore, it has been recently reported that, comparing to (super)hydrophilic surface, (super)hydrophobic surface enhances water bubble nucleation and thus speeds up the evaporation rate.¹³ FIG. 1.3 presents the design of device based on mesh/membrane as a substrate to house the photothermal nanomaterials, along with its proposed mode-of-application to solar water desalination. More specifically, the proposed device consists of a heat conductive porous substrate (e.g., mesh, membrane) being the base, onto which photothermal nanomaterials are deposited. The high abundance of the photothermal nanomaterials on the substrate surface is advantageous over the dispersed nanomaterials within the bulk water heating system as the fixed photothermal nanomaterials with high local concentration are expected to generate more concentrated local heat field with higher temperature. The wettability of the substrate is modulated so that it is superhydrophobic. Another design purpose for the hydrophobicity of the substrate is that the superhydrophobicity makes the device a perfectly self-floating device which stays on the surface of water and thus guarantees the precisely local heating of interfacial water. While the device floating on the water surface, under the illumination of solar light, the photothermal nanomaterials generate local heating within their close vicinity, giving rise to a local temperature gradient, which drives the nanomaterial-surface-generated water vapor to move into the overlying air phase. Compared to the bulk water heating system where a homogeneous high temperature is required for the entirety of the bulk water, a depth-dependent temperature gradient with a locally high temperature at the water surface is achieved (inset of FIG. 1.3) in the current superhydrophobic photothermal membrane system, which effectively drives water vapor, once generated, to leave the water surface and move into the air phase and thus enhances the energy efficiency. The (super) hydrophobicity makes the porous substrate an excellent barrier for separating water and vapor, and at the same time its porous structure facilitate the transportation of water vapor into air phase. Due to the immobilization of the photothermal nanomaterials on the substrate, there is no loss of the nanomaterials during operation, contributing to cost reduction. The proposed device, once prepared, would be suitable and affordable for point-of-use applications to supply drinking water, especially in the remote and rural areas, where access to centralized drinking water supply system is unavailable and other desalination technologies are not applicable.

### Preparation of Porous and Superhydrophobic Photothermal Substrate

Considering practical applicability, mechanical stability, easy availability and cost, metallic mesh, (e.g., aluminum, copper, stainless steel), and electrospun polymeric or inorganic nanofiber membranes will be chosen as the substrates. The photothermal nanomaterials to be explored include gold (Au) nanoparticles and nanorods, graphene nanosheets, carbon nanotubes, and carbon black. The nanomaterials will be prepared in our group according to well-known methods reported in the literature and then surface-treated to obtain their stable suspensions. Well-established facile and low-cost methods will then be employed to deposit the nanomaterials in their stable suspensions onto the substrates of choice, such as spray coating, dip coating, layer-by-layer (LbL) assembly deposition.¹⁴ The substrates with the deposited nanomaterials are then subject to hydrophobic modification to obtain superhydrophobic photothermal devices. The hydrophobic modification can be simply achieved by coating the substrates with a layer of low surface energy chemical, such as fluorosilanes or alkysilanes. Our group has extensive expertise in preparation of (super)hydrophilic, (super)hydrophobic, (super)oleophilic, and (super)oleophobic surfaces and is well equipped with the instruments required for these operations.¹⁵ For the purpose of comparison, the superhydrophobic substrates without the nanomaterials and the substrate with the nanomaterials but without the hydrophobic modification will also be prepared from the same porous substrates.

In parallel, preparation of substrate-free, self-standing photothermal devices will also be investigated. By utilizing the self-assembly or vacuum-filtration assisted assembly of certain fibrous photothermal nanomaterials, such as carbon nanofibers, carbon nanotubes, Au nanowires or nanorods, onto certain sacrificial substrates followed by the subsequent removal of the substrates, the photothermal nanomaterials based self-standing porous membranes can be obtained. For instance, carbon nanotubes can be easily deposited onto the cellulose filter membrane by a simple vacuum-filtration assisted assembly process, and upon the removal of the cellulose membrane by acetone, a self-standing carbon nanotube membrane can be obtained. The same hydrophobic modification will be applied to the self-standing membrane to obtain (super)hydrophobic photothermal devices.

### Performance Evaluation and Optimization of the Prepared Superhydrophobic Photothermal Membranes

Upon obtaining the superhydrophobic photothermal membranes, the efficiency of these membranes for the solar evaporation of water (seawater) will be tested. A small lab bench-scale setup, which mainly includes a solar simulator, a water container, and a real-time water mass monitoring system as shown in FIG. 1.1, will be built to characterize water evaporation efficiency by different superhydrophobic photothermal membranes. Under simulated solar light illumination, the variation of water mass in the container with different photothermal membranes floating on the water surface will be real-time monitored and the evaporation rate will thus be evaluated. The membranes will be further optimized in terms of water evaporation rates. The optimization parameters to be investigated include surface hydrophobicity, pore size of the membranes, and type of photothermal nanomaterials.

### Fabrication of a Device for the Point-of-Use Desalination: Evaporation of Seawater and Collection of Water Vapor

Utilizing the self-floating ability of the superhydrophobic photothermal membrane, a simple point-of-use all-in-one desalination device is designed as illustrated in FIG. 1.2. This device consists of light transparent walls and two chambers connected in their upper parts but separated in their lower parts by a division. One chamber is bottomed with the as-optimized (super)hydrophobic photothermal membrane, which enables the device to readily float on the surface of seawater or other type of source water. Under the nature solar illumination, this chamber evaporates the seawater and guides the water vapor into the upper chamber, where a solar-powered or a household battery-powered fan generates an air flow field and drives the water vapor into a condensing chamber to collect fresh water. The condensing chamber has a metallic or glass bottom in contact with the seawater and thus utilizes the seawater as a cold source to facilitate condensing. The optimization of the device configuration will be conducted to obtain high water collecting efficiency.

### REFERENCES

1 http://www.un.org/waterforlifedecade/scarcity.shtml
2 a) Shannon, M. A.; Bohn, P. W.; Elimelech, M.; Georgiadis, J. G.; Marinas, B. J.; Mayes, A. M. Nature 2008, 452, 301. b) Mark, F. Scientific American 2007, 297, 118.
3 Khawajia, A. D.; Kutubkhanaha, I. K.; Wie; J.-M. Desalination 2008, 221, 47.
4 M. Naim, A, Mervat, Abd. El-Kawi, Desalination 2003, 153, 55.
5 a) A. Luzzi,; Lovegrove, K. Solar Thermal Power Generation. Encyclopedia of Energy; Isevier Inc., 2004; Vol. 5, pp 669-683. b) Meier, A.; Gremaud, N.; Steinfeld, A. Energy Conyers. Manage. 2005, 46, 905.
6 a) Li, C. N.; Goswami, Y.; Stefanakos, E. Renewable and Sustainable Energy Reviews 2013, 19, 136. b) Sivakumar, V.; Sundaram E. G. Renewable and Sustainable Energy Reviews 2013, 18, 246.
7 a) Safwat, N. A.; Abdelkader, M.; Abdelmotalip, A.; Mabrouk, A. A. Energy Conversion and Management 2000, 41, 1797. b) Samee, M. Ali.; Mirza, U. K.; Majeed, T.; Ahmad, N. Renewable and Sustainable Energy Reviews 2007,11, 543. c) Velmurugan, V, Srithar, K. Renewable and Sustainable Energy Reviews 2011, 15, 1294.
8 a) Skrabalak, S. E.; Chen, J.; Au, L.; Lu, X.; Li, X.; Xia, Y. N. Adv. Mater. 2007, 19, 3177. b) Cole, J. R.; Mirin, N. A.; Knight, M. W.; Goodrich, G. P.; Halas, N. J. J. Phys. Chem. C 2009, 113, 12090. c) Huschka, R.; Zuloaga, J.; Knight, M. W.; Brown, L. V.; Nordlander, P.; Halas, N. J. J. Am. Chem. Soc. 2011, 133, 12247.
9 Gao, Y.; Yuan, Z.; Gao, S. W. J. Chem. Phys. 2011, 134.
10 a) Dreaden, E. C.; Mackey, M. A.; Huang, X. H.; Kang, B.; El-Sayed, M. A. Chem. Soc. Rev. 2011, 40, 3391. b) Neumann, 0.; Urban, A. S.; Day, J.; Lal, S.; Nordlander, P.; Halas, N. J. ACS Nano 2013, 7, 42. c) Jiang, R. B.; Cheng, S.; Shao, L.; Ruan, Q. F.; Wang, J. F. J. Phys. Chem. C 2013, 117, 8909.
11 a) Lal, S.; Clare, S. E.; Halas, N. J. Acc. Chem. Res. 2008, 41, 1842. b) Skirtach, A. G.; Dejugnat, C.; Braun, D.; Susha, A. S.; Rogach, A. L.; Parak, W. J.; Mohwald, H.; Sukhorukov, G. B. Nano Lett. 2005, 5, 1371. c) Ungureanu, C.; Kroes, R.; Petersen, W.; Groothuis, T. A. M.; Ungureanu, F.; Janssen, H.; van Leeuwen, F. W. B.; Kooyman, R. P. H.; Manohar, S.; van Leeuwen, T. G. Nano Lett. 2011, 11, 1887.
12 Nel, A.; Xia, T.; Mädler, L.; Li, N. Science 2006, 311, 622.
13 a) Vakarelski, I. U.; Patankar, N. A.; Marston, J. O.; Chan, D. Y. C.; Thoroddsen, S. T. Nature 2012, 489, 174. B) Dash, S.; Garimella, S. V. Phy Rev. E 2014, 89, 042402. c) Pan, Z. H.; Dash, S.; Weibel, J. A.; Garimella, S. V. Langmuir 2013, 29, 15831.
14 Li, Y.; Wang, X.; Sun J. Q. Chem. Soc. Rev. 2012, 41, 5998.
15. a) Zhang, L. B.; Zhong, Y. J.; Cha, D. K.; Wang, P. Sci Rep 2013, 3, 2326. b) Zhang, L. B.; Cha, D. K.; Wang, P. Adv. Mater. 2012, 24, 4756. c) Zhang, L. B.; Zhang, Z. H.; Wang, P. NPG Asia Mater. 2012, 4, e8.

### Example 2

Water evaporation driven by solar irradiation plays a critical role in global water cycle as well as in many industrial processes. However, the conventional solar evaporation experiences high energy loss and thus low evaporation rate due to its bulk water heating nature. Aiming at enhancing solar-driven evaporation, herein, we propose and demonstrate a novel interfacial heating membrane that spontaneously stays at the water-air interface, collects and converts solar light into heat, and locally heats only the water surface. A proof-of-concept membrane is prepared by deposition of light-to-heat conversion material of polypyrrole onto porous stainless steel mesh, followed by hydrophobic modification. Our results confirm that with the membrane floating on water surface, a sharp local temperature gradient is generated on the water surface, leading to significant water evaporation rate. The study also extends the interfacial heating membrane into solar water distillation and contributes a solar-driven point-of-use device for freshwater production.

### Introduction:

Water evaporation is an endothermic process, in which heat is absorbed. In nature, water evaporation is an important part of the global water cycle and is driven by solar radiation as heat source, which is abundantly and freely available.^{1,2} Generally, the solar irradiation penetrates water through a certain depth depending on water quality and the spectrum wavelength, and the water profile over the light passage length is heated up homogeneously. Over the history of mankind, this natural water evaporation has been widely imitated at various scales for beneficial uses.³⁻⁷ For example, in some remote and rural areas where access to centralized drinking water supply is unavailable, solar distillation is used to produce freshwater, which uses solar energy to heat and evaporate seawater or brackish water.⁵⁻⁷ However, the nature's way of water evaporation is imperfect, and it falls into the category of bulk heating, in which the entirety of bulk water is uniformly heated up. One fact that is often overlooked is that water evaporation is indeed a surface process, in which water molecules at the very thin air-water interface in the liquid water side, driven by their high energy state, are transported into the vapor phase. Thus, the conventional bulk heating of water is not a rational choice for water evaporation and it would unavoidably results in unnecessary heat/energy loss due to the energy transfer to the non-evaporative portion of the bulk water. It is thus not surprising that a major problem in the solar distillation and other solar evaporation processes is their low energy efficiency, similar to that in the natural water cycle.^{6,7}

Therefore, targeting at enhancing only the local temperature of interfacial water is more meaningful and energy-efficient for a high evaporation rate. The localized heating at the interfacial water can generate a sharper temperature gradient with the same level of energy input. In comparison to uniformly high temperature profile in the bulk water heating scheme, the localized high temperature of the interfacial water in the interfacial heating scheme minimizes the heat loss by the non-evaporative lower part of the bulk water due to its high temperature. To this end, herein, we propose a concept of gathering solar radiation only at the water-air interface to heat up only interfacial water and thus generating local temperature gradient to enhance water evaporation rate. In this study, the concept of interfacial heating is embodied by a self-floating hydrophobic membrane which houses highly-efficient light-to-heat conversion (photothermal) material⁸⁻¹⁶ that highly efficiently captures solar radiation and converts it to heat to generate local temperature gradient. Interfacial heating material in the form of membrane facilitates transportation of water vapor through the pores, and also benefits its operation and its integration into water distillation device for practical applications compared with powder-form materials.^{8,9}

Hydrophobic light-to-heat conversion mesh-based membrane with Wenzel's wetting behavior was prepared, which enables the membrane to spontaneously stay at the water-air interface and permits sufficient contact with the water surface so to precisely heat the interfacial water under the solar irradiation. Polypyrrole (PPy) was chosen in this study as the light-to-heat conversion material because of its broad spectrum absorption, high photothermal conversion efficiency, and its facile solution-based fabrication.¹⁴⁻¹⁶ For the membrane preparation, stainless steel (SS) meshes were used as the substrates, due to their good mechanical stability, intrinsic porous structures, as well as easy availability. The PPy coating was deposited on the mesh by in situ electropolymerization of pyrrole, followed by fluorosilane modification of the PPy coating to achieve desirable hydrophobicity. The surface hydrophobicity was controlled so that (1) the membrane could spontaneously float on water surface and stay at the water-air interface, and (2) the water wettability on the membrane surface conformed to Wenzel's behavior, instead of Cassie's one. Our results showed that with the such-designed photothermal membrane floating on water surface, water evaporation rate could be significantly enhanced under otherwise the same conditions. Furthermore, a prototype and all-in-one solar distillation device was prepared for efficient and point-of-use freshwater production.

Results and discussion:

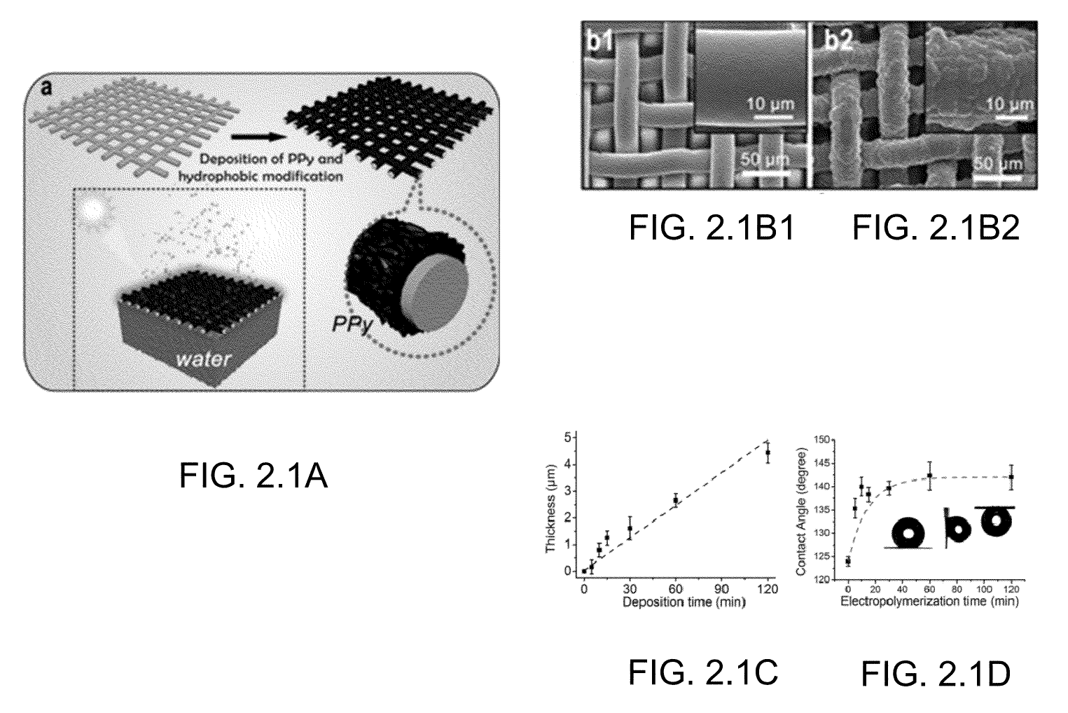

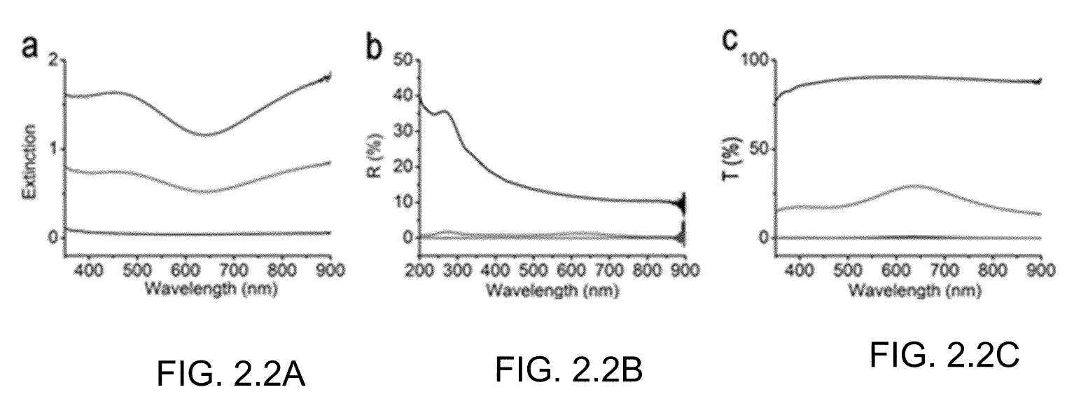

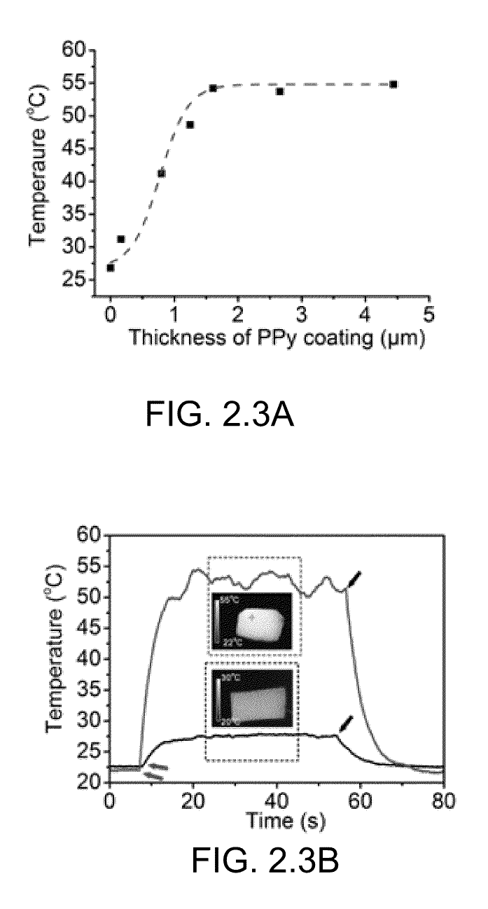

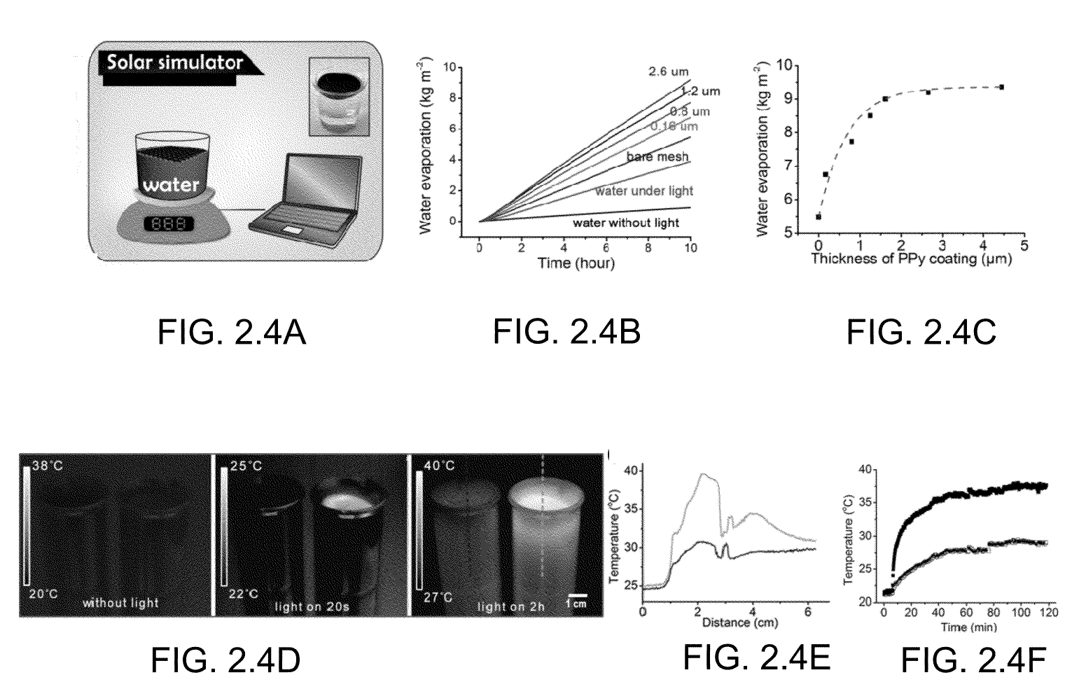

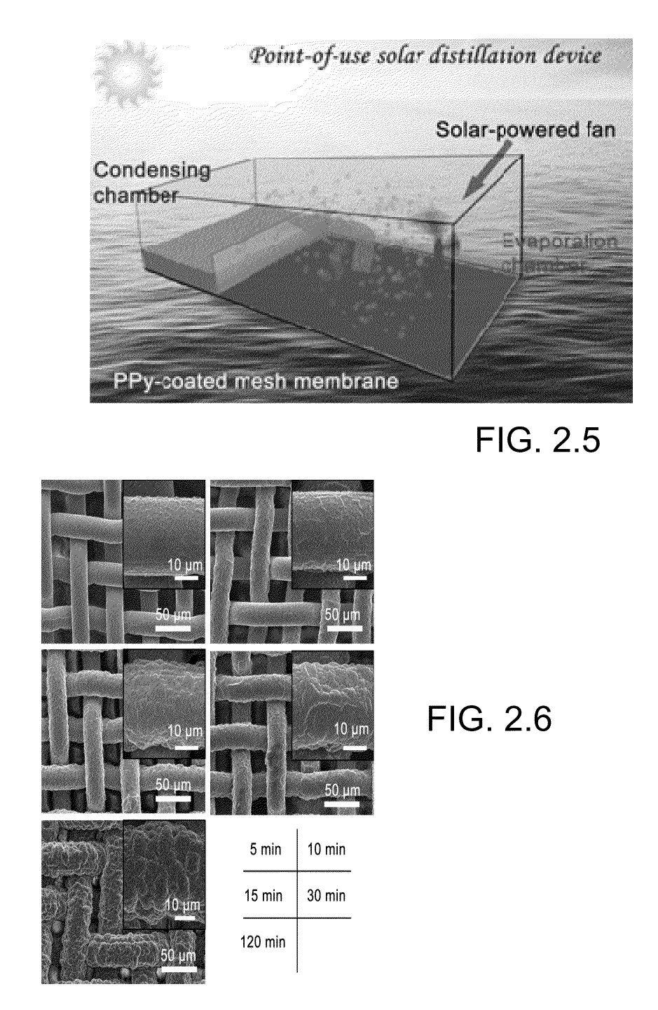

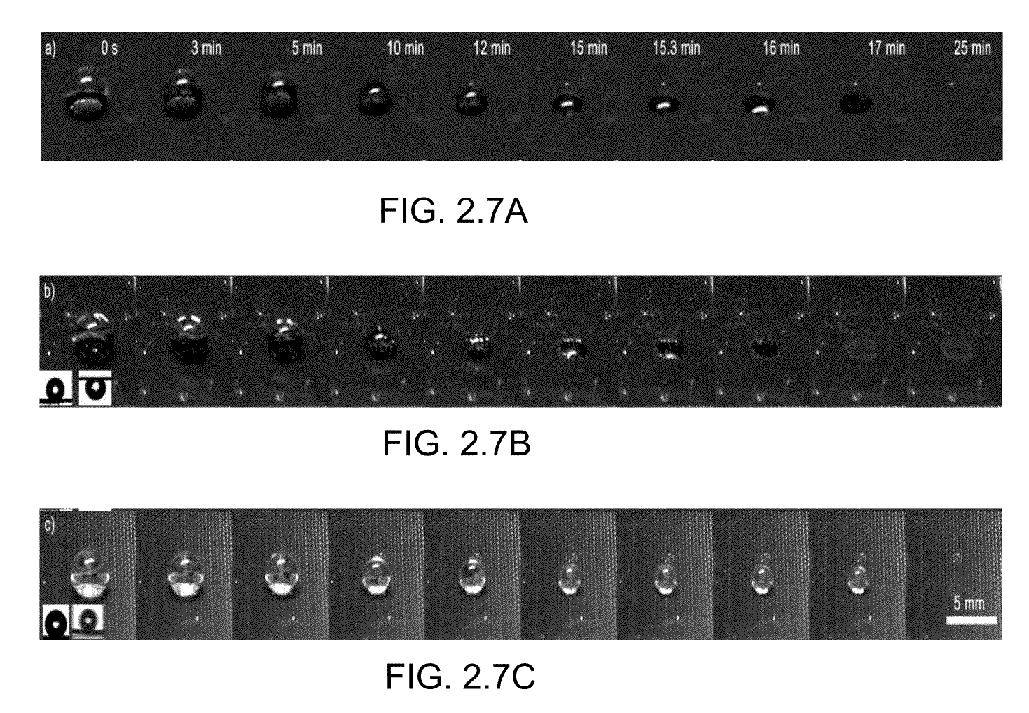

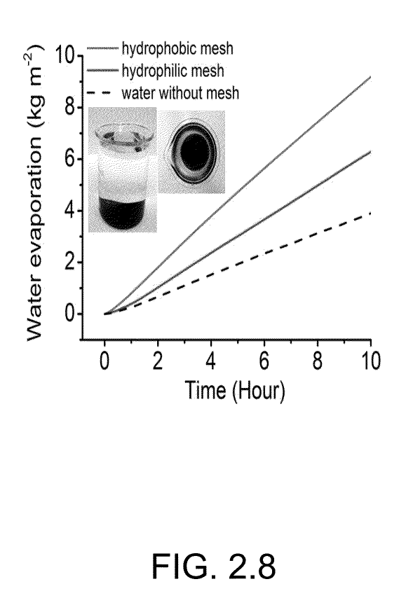

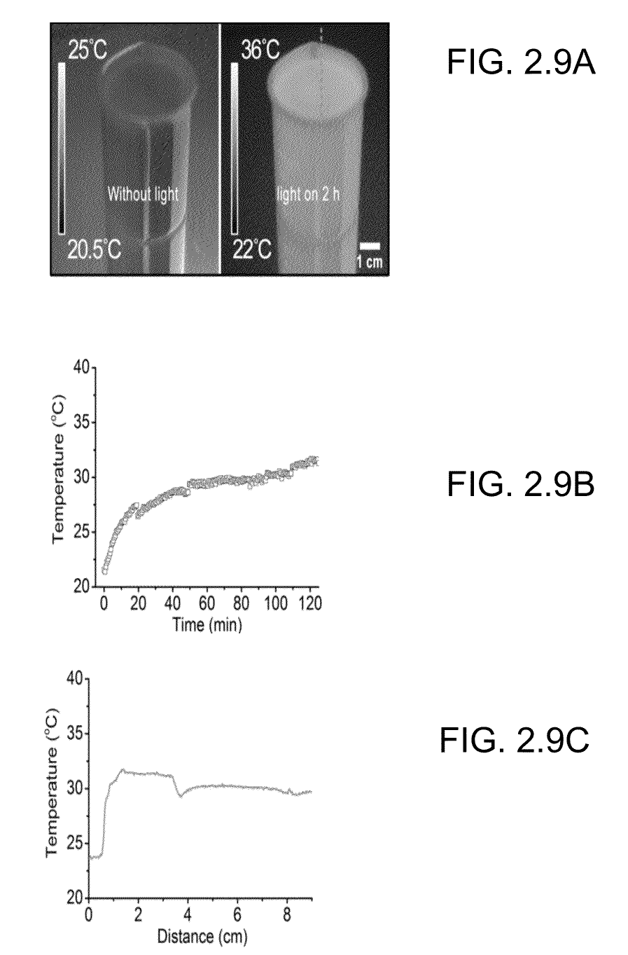

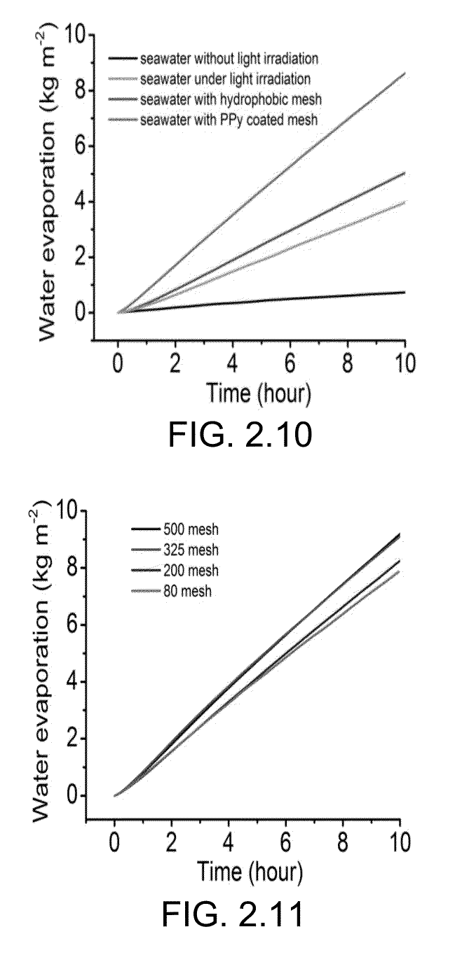

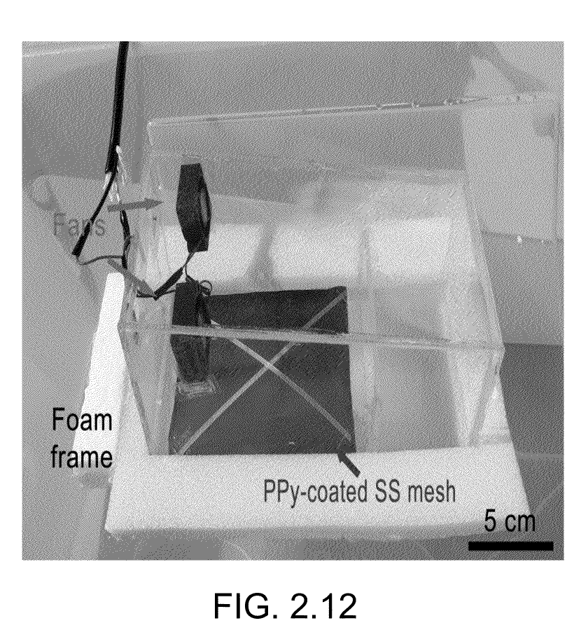

Our fabrication strategy of the self-floating photothermal membranes for the interfacial water heating is schematically shown in FIG. 2.1a. The PPy coating was deposited onto the meshes by electropolymerization of pyrrole. FIG. 2.1b shows the scanning electronic microscopic (SEM) images of the original unmodified SS mesh (500 mesh size) and the mesh deposited with PPy by electropolymerization for 1 hour. The original mesh with 500 mesh size has an average pore size of ˜26.8 μm (FIG. 2.1b1) and smooth wire surface, with knitting wire diameter of ˜24.5 μm. After the deposition of PPy, a PPy coating with micro-sized surface structures could be clearly seen (FIG. 2.1b2 and ESI FIG. 2.6). It has been found that the thickness of the PPy coating on the wires increased almost linearly with the electropolymerization time, with the coating thickness being ˜2.6 μm at 1-hour electropolymerization (FIG. 2.1c).

To achieve the self-floating capability, the PPy-coated meshes were then treated by chemical vapor deposition (CVD) of fluorosilane to reduce their surface energy.^{17,18} As shown in FIG. 2.1d, after the hydrophobic modification the meshes exhibited high water contact angles, which increased gradually with the electropolymerization time in the PPy deposition step. When the PPy deposition time exceeded 30 min, the contact angle reached a constant value of ˜140°. Furthermore, the meshes, although highly hydrophobic, exhibited high adhesion to water droplets. As shown in the insets of FIG. 2.1d, for the PPy-coated mesh prepared by 1-hour electropolymerization and fluorosilane modification, when the mesh was placed perpendicular and even inverted up-side down, the water droplets still firmly adhered to the surface. This wettability with high water contact angle as well as high adhesion to water droplets of the hydrophobic meshes is regarded as Wenzel's wetting behavior,¹⁸⁻²⁰ under which, although substrate surface exhibits a high contact angle, water is able to penetrate into the rough surface structures of the substrate and displace the otherwise air pockets present under Cassie's wetting.^{20,21} This Wenzel's wetting behavior of the meshes is a result of the combination of both the micro-sized surface structure and the hydrophobic modification. Under the Wenzel's wetting state, contact between the water and solid substrate surface is intimate and maximized, which is beneficial for the heat transfer from the mesh to water as air otherwise is considered as a poor heat conductor. A comparison of water evaporation rate between a Wenzel's and Cassie's wettability can be found in the Electronic Supporting Information (FIG. 2.7), which clearly demonstrates that significantly higher water evaporation is achieved under the Wenzel's wetting state than the Cassie's state under the otherwise same conditions.

Given the porous structure of the mesh substrate, a direct measurement of the light adsorption property of the PPy coating on the mesh deems impossible. Instead, to confirm the strong light absorption of PPy coating, a PPy coating was deposited onto an ITO glass substrate by electropolymerization method, followed by fluorosilane modification and the thus-prepared coating exhibited a broad absorption band, extending from the visible to the near infrared (NIR) region with two pronounced peaks at 450 nm and 850 nm, with the absorbance increasing with the thickness of the PPy coating, as shown in FIG. 2.2a. The broad band adsorption is characteristic of the bipolaronic metallic state of the doped polypyrrole.¹⁴⁻¹⁶ It is worth pointing out that (1) when the thickness of the PPy coatings were greater than 1.2 μm (i.e., with PPy deposition time >15 min), the absorbance of the PPy coatings saturated the limitation of the current UV-vis-NIR spectrophotometer; (2) the PPy coatings on the ITO glass showed negligible reflection and transmission (FIG. 2.2b and 2.2c); (3) the PPy coatings with and without fluorosilane modification exhibited almost the same light absorption spectra, indicating negligible influence of the fluorosilane modification on the photothermal property of the PPy coatings. All the above results demonstrated the strong light absorbance by the PPy coating.

The photothermal property of the PPy-coated meshes was then investigated. A simulated solar light with an intensity of 1000 Wm⁻² was shined on the PPy-coated meshes and an FLIR infrared camera was used to probe the temperature of the meshes in air. Under the light irradiation, a steady-state temperature for the meshes with the PPy coating could be reached, which is defined as the temperature when the heat generation under light irradiation and heat dissipation due to radiative heat flux is at equilibrium. FIG. 2.3a shows the steady-state temperature of the PPy-coated SS meshes as a function of the coating thickness. As can be seen, with the ambient temperature being constant at ˜22° C., the mesh temperature first increased steadily with the coating thickness before reaching a plateau (i.e., ˜55° C.) when the PPy coating thickness was beyond 1.6 μm. FIG. 2.3b presents the kinetics of temperature under light irradiation. Upon the simulated solar irradiation, the temperature of the PPy-coated mesh increased quickly to its steady-state temperature of 53±2° C. while for the original unmodified mesh showed a steady-state temperature of ˜27° C., which represented only ˜5° C. increased under the irradiation. It should be mentioned that because of its relatively low emissivity (˜0.16) of the original SS materials, the temperature of the unmodified mesh measured by the IR camera was a little lower than its actual temperature (˜30° C. as measured by a thermocouple). This result clearly demonstrated the efficient light-to-heat conversion property of the mesh, which was imparted by the PPy coating.

Having confirmed the photothermal effect, we then measured the water evaporation performance with the photothermal mesh membrane floating on water surface. FIG. 2.4a presents the schematic setup for the water evaporation measurement. Briefly, the photothermal membrane was placed and self-floated on water surface in a beaker, which was kept on an electronic balance to monitor the real-time water mass change. The same simulated solar light with an intensity of 1000 Wm⁻² was used and shined directly onto the self-floating membrane. As a control, in the absence of the membrane on the water surface, the water loss due to evaporation from the beaker with and without simulated solar light irradiation was 3.9 kg m⁻² and 0.88 kg m⁻² for 10 hours, respectively. Due to its hydrophobicity, the PPy-coated SS mesh spontaneously stayed at the water-air interface, and moved along with water surface during evaporation, which allows for automated and targeted interfacial water heating under light irradiation. FIG. 2.4b shows the mass of the water evaporated as a function of the irradiation time in the presence of the photothermal membranes. The amount of water evaporated increased first with increasing PPy coating thickness before reaching a plateau (i.e., ˜9.2 kg m⁻²) when the PPy coating thickness was 1.6 μm, as shown in FIG. 2.4c. Clearly, compared to the control case without the membrane, the water evaporation was greatly enhanced in the presence of membranes. For the mesh with the PPy coating thickness of 2.6 um, the water evaporation amounted to 9.2 kg m⁻² for 10 hours, which represented 235% that of the case without the membrane. Also, for a bare SS mesh (i.e., without PPy coating) with hydrophobic modification, which was also able to self-float on water surface, it produced 5.4 kg m⁻² for 10 hours.

To probe more into the mechanism of the enhanced water evaporation by the self-floating photothermal membrane, IR thermal images were captured and the temperature profiles of the water were analyzed. As shown in FIG. 2.4d, without the light irradiation, the water in both beakers with and without the membranes exhibited almost same homogeneous temperature profiles, and the temperature of the bulk water was both close to the room temperature of ˜22° C. Upon the light irradiation, the interfacial water temperature in the presence of the membrane increased immediately (middle in FIG. 2.4d), with a steady-state temperature as high as ˜39° C. FIG. 2.4f compares the water surface temperature profiles of two beakers as a function of the irradiation time and clearly an obvious enhancement was observed in the presence of the membrane. After 2 h light irradiation, the thermal image of the beaker with the surface self-floating membrane (the right panel of FIG. 2.4d) shows a sharper temperature gradient than the one without the membrane (FIG. 2.4e), where a homogeneous water temperature profile was obtained instead. The fact that, under solar irradiation, a uniform water temperature profile in the beaker in the absence of the membrane (the right panel in FIG. 2.4c) was obtained provides strong evidence that the heating without the membrane falls into the conventional bulk heating scheme. The results confirm our strategy of interfacial heating.

The light energy to heat of water evaporation conversion efficiency (η) of the photothermal membranes can be estimated by Equation (1):

¢=Qₑ/Qₛ (1)

Where Qₛ is the incidence light power (1000 W m⁻²), and Qₑ is the power of evaporation of the water, which can be estimated by Equation (2).

$${Q}_{e} = \frac{d m \times {H}_{e}}{d t} = υ \times {H}_{e} \qquad ( 2 )$$

where m is the mass of evaporated water, t is time, v is the evaporation rate of water, and Hₑ is the heat of evaporation of water (˜2260 kJ/kg). The water evaporation rate by the mesh with PPy coating thickness of 2.6 μm (prepared by 1-hour electropolymerization) was then calculated to be 0.92 kgm⁻² h⁻¹ and the conversion efficiency (η) of the mesh was ˜58%, which stands very favorably against the case without the membrane, whose conversion efficiency was only 24%. This conversion efficiency of the photothermal membrane for the light energy to heat of water evaporation is also higher than that of most of the current solar stills, which exhibited typical efficiencies in the range of 30˜45%.⁷

For the purpose of comparison, we also prepared a hydrophilic photothermal membrane of PPy-coated mesh and studied its water evaporation performance. First, it was found that once the hydrophilic PPy-coated mesh contacted the water, water spread and penetrated the pores of the mesh, and the mesh quickly sunk to the bottom of the beaker. More importantly, with the hydrophilic photothermal membrane at the bottom of the water, a much lower water evaporation rate was observed (see ESI FIG. 2.8). The thermal image revealed that, instead of locally high temperature around the mesh, a homogenous temperature profile in the overlying water column was produced (ESI FIG. 2.9), which presumably was caused by the convection within the water column due to density variation. We also tested seawater evaporation performance by our photothermal membranes and similar level of performance was obtained (ESI FIG. 2.10), which promises the self-floating photothermal membranes a high potential toward water desalination.

In this study, the mesh size is no trivial parameter as it determines pore size of the substrates and ESI FIG. 2.11 compares the water evaporation performance of the PPy-coated self-floating meshes with different sizes (80, 200, 325, and 500 mesh). It was found that the water evaporation rate increased with decreasing mesh pore size. The 500 mesh, which had the smallest pore size and thinnest wire diameter among these meshes, exhibited the highest evaporation rate. This is so because smaller pore size and wire diameter favors the deposited PPy to make more contact with the underlying water, and thus enhancing the conversion of light to heat.

The current strategy for the preparation of the self-floating photothermal membranes by electropolymerization of PPy onto SS mesh, followed with CVD of fluorosilane is also suited for large-scale fabrication, and therefore is potentially applicable for practical applications. In this study, a simple, and all-in-one solar distillation device was designed and fabricated as a prototype based on the concept of photothermal interfacial heating and the device is illustrated in FIG. 2.5 (also in ESI FIG. 2.12). This device consists of light transparent plastic walls and two chambers (evaporation chamber and condensing chamber) connected in their upper parts but separated in their lower parts by a division. The evaporation chamber is bottomed with the hydrophobic photothermal membrane, which spontaneously floats on the surface of seawater or other type of source water. Under the nature solar light illumination, this chamber evaporates the seawater and guides the water vapor into the upper chamber, where a solar-powered electrical fan generates an air flow field and drives the water vapor into a condensing chamber to collect freshwater. The condensing chamber with the plastic bottom is in direct contact with the seawater and thus utilizes the seawater as a cold source to facilitate condensation. The results showed that the device with a ˜120 cm² photothermal membrane (10×12 cm), when placed on the water surface, an amount of ˜9.0 g freshwater could be collected after 5-hour nature sunlight exposure. In a sharp contrast, the same device without the photothermal membrane collected only ˜0.6 g water under the same sunlight exposure. The enhanced water collection capability by the device with the photothermal membrane floating on the water surface is the result of a significant increased water surface temperature in the evaporation chamber, which speeds up the evaporation, and the-thus resulted temperature differences between the two chambers continuously drives the water to transport into the condensing chamber. Furthermore, the photothermal membranes are quite stable, and their water evaporation performance did not show obvious change even after long-term exposure (over 100 hours) to simulated solar light or natural sunlight. This result demonstrates the practical application of photothermal membrane for point-of-use freshwater production.

### Conclusion

In conclusion, we proposed and demonstrated an interfacial heating scheme, which involves accepting and converting solar light to heat only at water-air interface to generate a precisely local heating of only interfacial water to enhance water evaporation. The concept was embodied for the first time by a rational integration of surface hydrophobicity and light-to-heat conversion material onto mesh-based membranes, which exhibited significantly enhanced water evaporation rates in comparison to conventional bulk heating scheme. We believe that this study represents a new avenue for the design and fabrication of next-generation solar heating system and thus in the long term contributes to the global effort in addressing world water and energy issues.

### Experimental

### Materials.

HCl, and 1H,1H,2H,2H-perfluorooctyltriethoxysilane (POTS) were purchased from Sigma-Aldrich and pyrrole, and sodium dodecyl sulfate (SDS) were purchased from Acros. All these chemicals were used as received. Stainless steel (SS) meshes with different mesh sizes were purchased from Alfa Aesar (Karlsruhe, German). Deionized (DI) water purified in a Milli-Q (Millipore, Billerica, Mass., USA) system was used in all experiments.

### Preparation of Photothermal Membranes.

The SS meshes were cleaned with ethanol by sonication, rinsed with copious amount of ethanol and water, and dried with N₂ flow. Polypyrrole (PPy) was then deposited on the cleaned mesh via an electropolymerization process of pyrrole.²² Briefly, the cleaned SS mesh and Pt electrode were immersed in an aqueous electrolyte solution containing 0.5 wt % SDS, 0.01 M HCl, and 0.1 M pyrrole. An electrical potential of 1.5 V was applied between the SS mesh (anode) and Pt electrode (cathode) using a Keithley 2400 power supply for certain period of time. After the deposition of PPy coating on the mesh surface, the meshes were rinsed with copious of water to remove SDS from the surface before drying under N₂ flow. To reduce the surface energy, the PPy-coated SS meshes were modified with a fluorosilane of POTS by chemical vapor deposition to obtain hydrophobic surfaces.^{17,18}

### Characterization.

Scanning electron microscopy (SEM) images were obtained on an FEI Quanta 600 scanning electron microscope (FEI Company, Hillsboro, Oreg., USA). Contact angle and sliding angle measurements were performed with an OCA 35 (DataPhysics, Filderstadt, Germany) at ambient temperature using a 3 μL water droplet as the indicator. The temperature and the thermal images were captured using a FLIR A655 infrared camera. The simulated solar irradiation was provided by a 150 W Oriel Solar Simulator and the light intensity was adjusted to 1000 Wm⁻².

### REFERENCES

1 T. Oki and S. Kanae, Science, 2006, 313, 1068-1072.
2 N. S. Lewis, Science, 2007, 315, 798-801.
3 A. Razmjou, Q. Liu, G. P. Simon and H. Wang, Environ. Sci. Technol., 2013, 47, 13160-13166.
4 V. Velmurugana and K. Srithar, Renew. Sustain. Energy Rev., 2008, 12, 2253-2263.
5 R. D. Jackson and C. H. M. van Bavel, Science, 1965, 17, 1377-1379.
6 C. N. Li, Y. Goswami and E. Stefanakos, Renew. Sustain. Energy Rev., 2013, 19, 136-163.
7 A. E. Kabeel and S. A. El-Agouz, Desalination, 2011, 276, 1-12.
8 H. Ghasemi, G. Ni, A. M. Marconnet, J. Loomis, S. Yerci, N. Miljkovic and G. Chen, Nat. Comm., 2014, 5, 4449.
9 Y. Zeng, J. Yao, B. A. Horri, K. Wang, Y. Wu, D. Li and H. Wang, Energy Environ. Sci., 2011, 4, 4074-4078.
10 O. Neumann, A. S. Urban, J. Day, S. Lal, P. Nordlander and N. J. Halas, ACS Nano, 2013, 7, 42-49.
11 R. Jiang, S. Cheng, L. Shao, Q. Ruan and J. Wang, J. Phys. Chem. C, 2013, 117, 8909-8915.
12 E. Miyako, T. Deguchi, Y. Nakajima, M. Yudasaka, Y. Hagihara, M. Horie, M. Shichiri, Y. Higuchi, F. Yamashita, M. Hashida, Y. Shigeri, Y. Yoshida and S. Iijima, Proc. Natl Acad. Sci. USA, 2012, 109, 7523-7528.
13 D. Jaque, L. M. Maestro, B. del Rosal, P. Haro-Gonzalez, A. Benayas, J. L. Plaza, E. M. Rodríguez and J. García Solé, Nanoscale, 2014, 6, 9494-9530.
14 K. Yang, H. Xu, L. Cheng, C. Sun, J. Wang and Z. Liu, Adv. Mater., 2012, 24, 5586-5592.
15 Z. Zha, X. Yue, Q. Ren and Z. Dai, Adv. Mater., 2013, 25, 777-782.
16 M. Chen, X. Fang, S. Tang and N. Zheng, Chem. Commun., 2012, 48, 8934-8936.
17 Y. Li, L. Li and J. Q. Sun, Angew. Chem., Int. Ed., 2010, 49, 6129-6133.
18 L. B. Zhang, J. B. Wu, M. Hedhili, X. L. Yang and P. Wang, J. Mater. Chem. A, 2015, 3, 2844-2852.
19 R. N. Wenzel, Ind. Eng. Chem., 1936, 28, 988-994.
20 S. Wang and L. Jiang, Adv. Mater., 2007, 19, 3423-3424.
21 A. B. D. Cassie and S. Baxter, Trans. Faraday Soc., 1944, 40, 546-551.
22 T. An, S. J. Cho, W. S. Choi, J. H. Kim, S. T. Lim and G. Lim, Soft Matter, 2011, 7, 9867-9870.

### Supplemental Example 2 Discussion:

Preparation of the superhydrophobic copper (Cu) mesh with Cassie's wetting behavior.

The superhydrophobic surface on a Cu mesh was prepared following a literature method with slight modification.¹ Briefly, a pre-cleaned Cu mesh (80 mesh) was first immersed in 4.0 M HCl aqueous solution for 5 seconds to remove surface oxide layer and then washed with copious ethanol and DI water. Next, the cleaned Cu mesh was incubated in an aqueous solution of 2.5 M NaOH and 0.1 M (NH₄)₂S₂O₈ at 4° C. for 60 minutes to from Cu(OH)₂. Then the blue mesh was thoroughly washed with water and dried at 180° C. for 2 h to convert Cu(OH)₂ into stable CuO by dehydration. Finally, the black copper mesh was coated with POTS by chemical vapor deposition to obtain superhydrophobicity.

Influence of the surface wetting behaviors on the heat transfer.

To verify that the surface with Wenzel's wetting behavior has better heat transfer capability than the Cassie's one, the evaporation of water droplets on surfaces with Wenzel's and Cassie's wetting behaviors was compared. The hydrophobic PPy-coated (with 1 h PPy deposition) SS meshes (80 and 500 mesh) and the superhydrophobic Cu mesh were attached on a hot plate by using conducting Cu adhesive. The temperature of the meshes was maintained at 45° C. Then water droplets with volume of 20 μL were carefully placed on the meshes, and the time course of evaporation of the water droplets was recorded by a digital camera (FIG. 2.7). The wetting behaviors of the water droplets on these mesh surfaces are shown in the insets of FIG. 2.7 on the left. The superhydrophobic Cu mesh showed a contact angle of 157° and sliding angle less than 1°, which indicates a Cassie's wetting behavior. Under the Cassie's wetting state, water droplets sit on the solid-air composite surface and interact only with a small fraction of the solid surface.^{2,3}

In comparison, for both the PPy-coated SS meshes with different mesh size, a Wenzel's wetting behavior was observed with a water contact angle of ˜140° and a high adhesion to the droplets. As shown in FIG. 2.7, the water droplets on the PPy-coated SS meshes showed a faster evaporation rate compared with that on the superhydrophobic Cu mesh. It took both PPy-coated SS meshes ˜17 min, while ˜25 min for the superhydrophobic Cu mesh to evaporate off the same volume of water droplets. On the PPy-coated SS meshes, in the course of water droplet evaporation, a constant contact area was observed as the size of the droplets was decreasing due to evaporation, indicating a sufficient contact and thus heat transfer between the droplets and the underlying substrates. For the superhydrophobic Cu mesh with a Cassie's wetting behavior, a gradual shrinkage in the water droplet diameter was observed instead, and the water droplet maintained its spherical shape in the course of evaporation. On such a surface, the existence of the air pockets with low thermal conductivity and the limited contact between the droplets and underlying solid surface decreases the heat transfer, and thus inhibits water evaporation.

### SUPPLEMENTARY REFERENCES

1 L. B. Zhang, J. B. Wu, M. Hedhili, X. L. Yang and P. Wang, J. Mater. Chem. A, 2015, 3, 2844-2852.
2 S. Wang and L. Jiang, Adv. Mater., 2007, 19, 3423-3424.
3 A. B. D. Cassie and S. Baxter, Trans. Faraday Soc., 1944, 40, 546-551.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Unless indicated otherwise, parts are parts by weight, temperature is in ° C., and pressure is at or near atmospheric. Standard temperature and pressure are defined as 20° C. and 1 atmosphere.

It is noted that, as used in the specification and the appended claims, the singular forms “a,” “an,” and “the” include plural referents unless the context clearly dictates otherwise.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, “about 0” can refer to 0, 0.001, 0.01, or 0.1. In an embodiment, the term “about” can include traditional rounding according to significant figures of the numerical value. In addition, the phrase “about ‘x’ to ‘y’” includes “about ‘x’ to about ‘y’”.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

What is claimed is:

1. A hydrophobic photothermal membrane, comprising:
a porous structure having a surface and a plurality of photothermal nanomaterials, wherein the surface has a characteristic selected from a hydrophobic characteristic or a superhydrophobic characteristic.

2. The membrane of claim 1, wherein the membrane is obtained by the deposition of photothermal nanomaterials on the porous substrate or self-assembly of the photothermal nanomaterials, followed by a low surface energy chemical modification.

3. The membrane of claim 2, wherein the porous substrate is selected from a metallic mesh, an electrospun fibrous mat, paper, a polymeric membrane, or a sponge.

4. The membrane of claim 3, wherein the metallic mesh is made of a material that is selected from: copper, iron, stainless steel, bronze, nickel, titanium, aluminum, silver, gold, palladium, platinum, silicon, zirconium, cobalt, lead, an alloy thereof, an oxide thereof, or a mixture thereof.

5. The membrane of claim 3, wherein the electrospun fibrous mat, paper, or polymeric membrane are made of a material selected from: cellulose, nylon, polyester, polyethylene terephthalate, polyurethane polylactide, polypropylene, polyethylene, polysulfone, polyamide, polyvinyl chloride, polytetrafluoroethylene, polycarbonate, polyacrylonitrile, polybuylene polybutylene terephthalate, polyimide, polymethyl, methacrylate, polyetheretherketone, polyetherketone, polyetherimide, polyethersulfone, polymethylpentene, polyoxymethylene, polyphthalamide, polyphenylene oxide, polyphenylene sulfide, ethylene propylene rubber, styrene butadiene rubber, ethylene propylene diene monomer rubber, polydimethylsiloxane, poly(phenyl methyl siloxane), poly(4-dimethylsilyl styrene), poly(4-methyl styrene), poly(isobutylene), poly(N-isopropylacrylamide), polyacrylamide, polypyrrole, polythiophene, polyaniline, or a mixture or blend thereof.

6. The membrane of claim 3, wherein the sponge is made of a material selected from: cellulose, nylon, polyester, polyethylene terephthalate, polyurethane polylactide, polypropylene, polyethylene, polysulfone, polyamide, polyvinyl chloride, polytetrafluoroethylene, polycarbonate, polyacrylonitrile, polybuylene polybutylene terephthalate, polyimide, polymethyl, methacrylate, polyetheretherketone, polyetherketone, polyetherimide, polyethersulfone, polymethylpentene, polyoxymethylene, polyphthalamide, polyphenylene oxide, polyphenylene sulfide, ethylene propylene rubber, styrene butadiene rubber, ethylene propylene diene monomer rubber, polydimethylsiloxane, poly(phenyl methyl siloxane), poly(4-dimethylsilyl styrene), poly(4-methyl styrene), poly(isobutylene), poly(N-isopropylacrylamide), polyacrylamide, polypyrrole, polythiophene, polyaniline, or a mixture or blend thereof.

7. The membrane of claim 2, wherein the photothermal nanomaterial is made of a material selected from: gold nanoparticles, nanowires or nanorods; graphene nanosheets; carbon nanotubes; carbon black, carbon nanofibers; silver nanoparticles, nanowires, or nanorods; polypyrrole nanoparticles, nanowires, or nanorods; polyaniline nanoparticles, nanowires, or nanorods; polythiophene nanoparticles, nanowires, or nanorods; poly(3,4-ethylenedioxythiophene) nanoparticles, nanowires, or nanorods;
platinum polypyrrole nanoparticles, nanowires, or nanorods; CuS, CuO, CuSe, nanoparticles; porous silicon nanoparticles, iron oxide nanoparticles, nanowires, or nanorods, or a mixture thereof.

8. The membrane of claim 2, wherein the deposition is produced by: layer-by-layer assembly, spray coating, dip coating, chemical vapor deposition, physical vapor deposition, or by a combination thereof.

9. The membrane of claim 2, wherein the self-assembly comprises layer-by-layer assembly or vacuum filtration induced self-assembly.

10. The membrane of claim 2, wherein the low surface energy chemical modification includes the use of a low surface energy chemical that is selected from: fluoroalkylsilane and alkylsliane, including 1H,1H,2H,2H-perfluorooctyltriethoxysilane, 1H,1H,2H,2H-perfluorododecyltrichlorosilane, 1H,1H,2H,2H-perfluorodecyltriethoxysilane, trichloro(3,3,3-trifluoropropyl)silane), hexyltrimethoxysilane, dimethoxy(methyl)octylsilane), trichloro(octadecyl)silane, trichloro(octyl)silane, trimethoxy(octadecyl)silane, teflon, polyvinylidene fluoride, polydimethylsiloxane, or a combination thereof.

11. A water distillation device, comprising:
a hydrophobic photothermal membrane a porous structure having a surface and a plurality of photothermal nanomaterials, wherein the surface has a characteristic selected from a hydrophobic characteristic or a superhydrophobic characteristic,
a condensation unit, wherein the membrane and the condensation unit are partially separated by a wall,
wherein water vapor permeates the photothermal membrane and condenses in the condensation unit.

12. The device of claim 11, wherein the membrane is obtained by the deposition of photothermal nanomaterials on the porous substrate or self-assembly of the photothermal nanomaterials, followed by a low surface energy chemical modification and wherein the porous substrate is selected from a metallic mesh, an electrospun fibrous mat, paper, polymeric membrane, or a sponge.

13. A process of desalination, comprising:
placing a device on the surface of a body of saltwater or wastewater, wherein the device floats on the surface of the water;
exposing the membrane to a light energy, wherein the light energy is converted to thermal energy, wherein the thermal energy causes the porous substrate to increase in temperature;
vaporizing the water in contact with the bottom surface of the membrane on the side opposite the photothermal nanoparticles, wherein the water vapor passes through the pores of the porous substrate; and
condensing the water vapor in a condensation unit that is separated from the membrane.

14. The process of claim 13, wherein the device includes a hydrophobic photothermal membrane.

15. The process of claim 14, wherein the hydrophobic photothermal membrane includes a porous structure having a surface and a plurality of photothermal nanomaterials, wherein the surface has a characteristic selected from a hydrophobic characteristic and a superhydrophobic characteristic.

16. The process of claim 14, wherein the hydrophobic photothermal membrane includes a condensation unit, wherein the membrane and the condensation unit are partially separated by a wall, wherein water vapor permeates the photothermal membrane and condenses in the condensation unit.
